(19) United States
(12) Patent Application Publication
(10) Pub. No.: US 2013/0314003 A1
(43) Pub. Date: Nov. 28, 2013

(54) DRIVING CIRCUIT FOR BACKLIGHT LED

(71) Applicants: Hong Fu Jin Precision Industry (ShenZhen) Co., Ltd., (US); HON HAI PRECISION INDUSTRY CO., LTD., New Taipei (TW)

(72) Inventors: JIE-SONG ZHOU, Shenzhen (CN); XIAO-QING ZHANG, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/726,236

(22) Filed: Dec. 24, 2012

(30) Foreign Application Priority Data
May 22, 2012 (CN) 201210159313.2

(51) Int. Cl. H05B 37/02

(52) U.S. Cl. CPC H05B 37/02
USPC 315/307

(57) ABSTRACT

A driving circuit for backlight LED comprises a power input, a control module, a voltage promotion module and a filter circuit module. The filter circuit is connected between the power input and the voltage promotion module. The filter circuit module is configured to filter ripple voltage signals from the power source and periodic voltage echo wave signals from the voltage promotion module to eliminate the “water wave” on a LCD display.

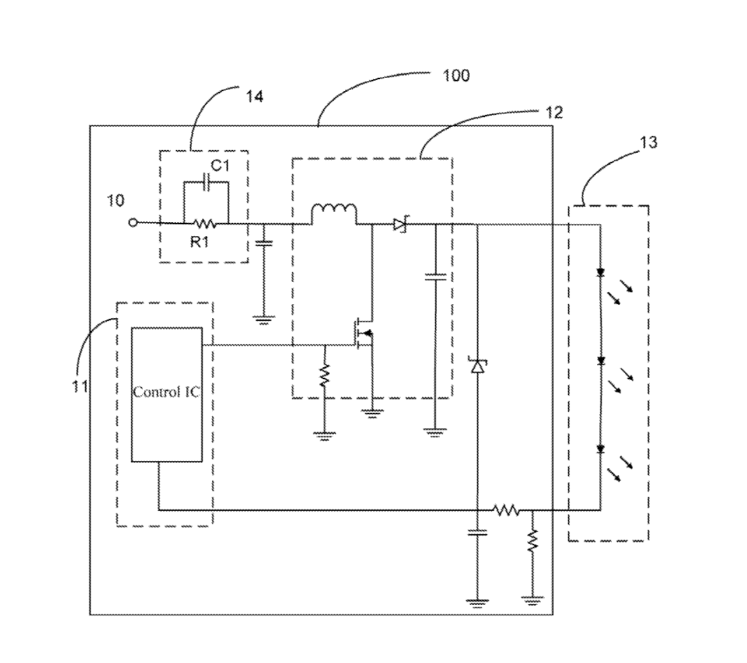

### BACKGROUND

1. Technical Field

Embodiments of the present disclosure relates to driving circuits for backlight light-emitting diode (LED), and particularly, to a driving circuit for backlight LED that could effectively eliminate the “water wave” on a liquid crystal display (LCD) display.

2. Description of Related Art

LCD displays of many portable consumer electronic devices basically use LED backlight. The LCD display is always connected to a main board of an electronic device through a flexible flat cable which includes power lines, signal lines, and a ground line. A backlight LED driving circuit includes an LED power and a voltage promotion module. The ripple voltage signals from the LED power source and periodic voltage echo wave signals from the voltage promotion module may couple with the flexible flat cable and interferes the digital singles and generates “water wave” on the LCD display.

### BRIEF DESCRIPTION OF THE DRAWINGS

The drawing is a functional block diagram of one embodiment of an LED driving circuit.

### DETAILED DESCRIPTION

The disclosure, including the accompanying drawings in which like references indicate similar elements, is illustrated by way of examples and not by way of limitation. It should be noted that references to “an” or “one” embodiment in this disclosure are not necessarily to the same embodiment, and such references mean at least one.

The drawing is a functional block diagram of one embodiment of an LED driving circuit 100. The LED driving circuit 100 includes a power input 10, a control module 11, a voltage promotion module 12, and a filter circuit module 13. The LED driving circuit 100 is used to drive the backlight LED module 14. The power input 10 is connected to a power source (not shown), such as a battery or a adapter. The control module 11 is used to generate pulse width modem (PWM) signals for controlling the voltage promotion module 12 in response to a backlight adjustment signal generated due to a user input or a feedback from an optical sensor (not shown). The voltage promotion module 12 is connected among the power input 10, the control module 11, and the backlight LED module 14. The voltage promotion module 12 receives voltage signals from the power input 10 and converts the received voltage signals into appropriated driving voltage signals based on the PWM signals from the control module 11. The driving voltage signals are applied to the backlight LED module 14. The filter circuit module 13 is connected between the power input 10 and the voltage promotion module 12. The filter circuit module 13 is used for filtering the ripple voltage signals from the power source and the periodic voltage echo wave signals from the voltage promotion module 12.

In the embodiment, the filter circuit module 13 includes an resistor R1 and a capacitor C1. The resistor R1 and the capacitor C1 are connected to the power input 10 and the voltage promotion module 12 in parallel. The resistance of the resistor R1 is about two ohms The capacitance of the capacitor C1 depends on the frequency of the PWM signals, specifically, the time that the capacitor C1 is charged and discharged is greater than the reciprocal of the frequency of the PWM signal. In the embodiment, the time that the capacitor C1 is charged and discharged is about 5-6 times of the reciprocal of the frequency of the PWM signals, and equals to the product of the resistance of the resistor R1 and capacitance of the capacitor C1.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A driving circuit for backlight light-emitting diode (LED), comprising:
a power input configured to receive voltage signals from a power source;
a voltage promotion module configured to generate a driving voltage signal to driving a backlight LED module;
a control module configured to generate a pulse width modem (PWM) signal corresponding to a backlight adjustment signal to the voltage promotion module; and
a filter circuit module configured to filter ripple voltage signals from the power source and periodic voltage echo wave signals from the voltage promotion module;
wherein the voltage promotion is connected with the power input, the control module and the backlight LED module, the filter circuit module is connected between the power input and the voltage promotion module.

2. The driving circuit for backlight LED as described in claim 1, wherein the filter circuit module includes a resistor and a capacitor, the resistor and the capacitor are connected between power input and the voltage promotion module in parallel.

3. The driving circuit for backlight LED as described in claim 2, wherein the resistance of the resistor is less than two ohms

4. The driving circuit for backlight LED as described in claim 2, wherein the capacitance of the capacitor depends on a frequency of the PWM signal.

5. The driving circuit for backlight LED as described in claim 4, wherein a product of the resistance of the resistor and capacitance of the capacitor is greater than the reciprocal of the frequency of the PWM signal.

6. The driving circuit for backlight LED as described in claim 5, wherein the product of the resistance of the resistor and capacitance of the capacitor is 5-6 times of the reciprocal of the frequency of the PWM signals.
